(19) United States
(12) Patent Application Publication
(10) Pub. No.: US 2014/0343983 A1
(43) Pub. Date: Nov. 20, 2014

(54) SYSTEM AND A METHOD FOR OPTIMIZATION AND MANAGEMENT OF DEMAND RESPONSE AND DISTRIBUTED ENERGY RESOURCES

(71) Applicants: Amit Narayan, Cupertino, CA (US); Henry Schwarz, Foster City, CA (US); Rajeev Kumar Singh, Redwood City, CA (US); Vijay Srikrishna Bhat, San Francisco, CA (US); Abishek Bahl, San Francisco, CA (US)

(72) Inventors: Amit Narayan, Cupertino, CA (US); Henry Schwarz, Foster City, CA (US); Rajeev Kumar Singh, Redwood City, CA (US); Vijay Srikrishna Bhat, San Francisco, CA (US); Abishek Bahl, San Francisco, CA (US)

(73) Assignee: AUTOGRID INC., Redwood Shores, CA (US)

(21) Appl. No.: 14/345,248

(22) PCT Filed: Sep. 14, 2012
(86) PCT No.: PCT/US2012/000399

§ 371 Date: Mar. 16, 2014

Related U.S. Application Data
(60) Provisional application No. 61/535,365, filed on Sep. 16, 2011.
(60) Provisional application No. 61/535,369, filed on Sep. 16, 2011.
(60) Provisional application No. 61/535,371, filed on Sep. 16, 2011.

(51) Int. Cl. G06Q 50/06; G06Q 10/06

(52) U.S. Cl. CPC G06Q 50/06; G06Q 10/0631
USPC 705/7.12

(57) ABSTRACT

A system and a method for optimization and management of Demand Response in real time manner is provided. The system employs a resource modeler, a forecasting engine, an optimizer, a dispatch engine, and a baseline engine. The system is built using open framework standards based signaling and data collection, and is offered under a “Software-as-a-Service” model to significantly reduce the cost of participation in demand response. It uses off the shelf information and communication technology (ICT) and controls equipment.

### CROSS-REFERENCE TO RELATED APPLICATION(S)

This application claims the benefit of priority to U.S. Provisional Patent Application No. 61/535,369, filed Sep. 16, 2011, entitled “Software-as-a-Service (SaaS) for Optimization and Management of Demand Response and Distributed Energy Resources”, and claims the benefit of priority to U.S. Provisional Patent Application No. 61/535,371, filed Sep. 16, 2011, entitled “Multi-Channel Communication of Demand Response Information between Server and Client”, and claims the benefit of priority to U.S. Provisional Patent Application No. 61/535,365, filed Sep. 16, 2011, entitled “System and Method for Optimization of Demand Response and Distributed Energy Resources and Management Thereof”, the contents of each of which are hereby incorporated by reference in their entireties.

### FIELD OF THE INVENTION

The present invention relates generally to a demand response (DR) and management of distributed energy resources (DER) system and more particularly to a system and method for optimization and management of demand response (DR) and distributed energy resources (DER) for real time power flow control to support large scale integration of distributed renewable generation into the grid.

### BACKGROUND

The growth in the demand for energy makes it increasingly important to find alternative sources of energy. One solution is to create new sources of energy and another is to conserve the energy. The past few years have seen implementation of “demand response” (DR) programs. Demand response is a mechanism to manage customer consumption of electricity in response to supply conditions, for example, having electricity customers reduce their consumption at critical times or in response to market prices. Demand response is generally used to encourage consumers to reduce demand, thereby reducing the peak demand for electricity. Demand response gives the consumers the ability to voluntarily trim or reduce their electricity usage at specific times of the day during high electricity prices, or during emergencies.

In other words, demand response is a resource that allows end-use electricity customers to reduce their electricity usage in a given time period, or shift that usage to another time period in response to a price signal, a financial incentive, an environmental condition, or a reliability signal. Demand response saves ratepayer's money by lowering peak time energy usage that is high-priced. This lowers the price of wholesale energy, and in turn, retail rates. Demand response may also prevent rolling blackouts by offsetting the need for more electricity generation and can mitigate generator market power.

Traditionally, price-based DR has been used to shift peak load but has not adequately addressed other electrical properties such as congestion or power quality. DROMS-RT targets loads within subLAPs (load aggregation points) and enable valuable management of congestion constrained electric grids with subLAP granularity. Such a consideration of grid physics not only increases the value of DR, it makes the grid more reliable and resilient to contingencies especially as renewable and demand resource penetration increases

Existing demand response programs offer comparatively coarse control providing jagged responses that are often difficult to distinguish from normal whole site electric meter profiles using traditional baseline techniques. Sheds are often “open-loop” with whole site interval meter data available the next day at the earliest. When closed-loop controls are used to target a specific shed value, ramp-rates are still substantially uncontrolled. Traditional telemetry equipment costs upwards of $20,000 per monitored load. Demand response resource dispatch using self-calibrated load specific model based closed loop control has not been disclosed in the prior models. Low-cost (sub $200) load level telemetry and learning algorithms using other advanced inputs for model creation, dispatch tuning, performance optimization have never been done.

Today, all of these programs sit in their separate silos and there is no way to coordinate the execution of these programs over geographies and customers. This leads to a significant reduction in overall efficiency of the system. The present invention provides a unified view of all DR resources across all programs and optimally dispatching these resources will make the system significantly more efficient.

### BRIEF SUMMARY OF THE INVENTION

Accordingly in an aspect of the present invention, a demand response optimization and management system for real time (DROMS-RT) is provided. The system comprises a resource modeler to keep track of all the available DR (demand response) resources, their types, their locations and other relevant characteristics such as response times, ramp-times etc.; a forecasting engine to perform short-term forecasts of aggregate load and available load-sheds for individual loads connected to the system; an optimizer to determine the optimal dispatch of demand response under a given cost functions; a dispatch engine; and a baseline engine to provide the capability of detecting demand reduction in response to a demand response event or price notification for significantly reducing the cost of participation in demand response.

In another aspect of the present invention a signal processing technique that are used in baseline computation engine for detecting small signals in the background of very large baseline signals is provided. The technique determines the baseline signals and reduces the loads in the presence of the baseline noise.

### BRIEF DESCRIPTION OF THE DRAWINGS

The preferred embodiment of the invention will hereinafter be described in conjunction with the appended drawings provided to illustrate and not to limit the scope of the invention, wherein like designation denote like element and in which:

FIG. 1 is a schematic representation illustrating the operation of demand response optimization and management system for real time (DROMS-RT) in accordance with an embodiment of the present invention.

FIG. 2 illustrates a dynamic demand response resource model, in accordance with an embodiment of the present invention.

FIG. 3 is a representation illustrating alternate signal enhancement strategies and SNR enhancement via customer aggregation in accordance with an embodiment of the present invention.

### DETAILED DESCRIPTION OF THE EMBODIMENTS

DROMS-RT is a highly distributed Demand Response Optimization and Management System for Real-Time power flow control to support large scale integration of distributed generation into the grid.

Demand response programs help in reducing the energy costs and system integrity for a few critical hours during the year. The demand response programs also encourage end customers to reduce load at their facilities, and to participate in the price response program or enter into the forward capacity market through a demand response provider. Demand Response services are substantially less expensive and cleaner than other forms of ancillary services options currently available.

In an embodiment of the present invention, a scalable, web-based software as a service platform is provided that provides all program design, resource modeling, forecasting, optimal dispatch, and measurement functionality. The invention provides a method to optimize demand response and distributed energy resources (DER) and is offered under software as a service model that provides a platform to reduce the cost of deployment and facility, and allow all small commercial and residential customers to participate in demand response. The demand response optimization and management system for real time is built using open framework standards based signaling and data collection, and it is offered under a “Software-as-a-Service” model to significantly reduce the cost of participation in demand response. It uses off the shelf information and communication technology (ICT) and controls equipment.

A closed feedback loop is provided in the system so that the system continues to optimize performance, increase predictability, and minimize loss of service through analysis of ongoing events.

In an embodiment of the present invention, a system to achieve maximum efficiency in demand response and distributed energy resources (DER) is introduced using the software as a service model.

The system can manage a portfolio of demand response resources of various performance characteristics over a given time-horizon that would span both day-ahead and near real-time situations. The system can automatically select the mix of demand response resources best suited to meet the needs of the grid (such as reduce congestion in targeted regions, provide contingency peak reduction, regulation and other ancillary services).

The system uses advanced machine learning and robust optimization techniques for real-time and “personalized” demand response-offer dispatch. It keeps a unified view of available demand side resources under all available demand response programs and history of participation in different demand response events at individual customer locations. The demand response resource models are dynamic as it is based on current conditions and various advanced notice requirements.

The system eliminates barrier towards offering new programs. Utilities will be able to experiment with new programs in an easy and cost-effective manner. Furthermore, utilities will be able to introduce many more programs to serve different sectors of the customer, and thereby achieve higher acceptance and customer satisfaction. It will improve the efficiency of the system and achieve cost-savings. The system provides highly dispatchable demand response services in timeframes suitable for providing ancillary services to the grid. The system can use a multitude of signaling technologies such as cellular, broadband Internet, AMI infrastructure, RDS, e-mail etc and signaling protocols such as OpenADR, Smart Energy Profile 1.x/2.x among others. The system will also leverage low-cost, internet-protocol based telemetry solutions to reduce the cost of hardware. This will allow the system to provide dynamic price signals to millions of OpenADR (automated demand response) clients.

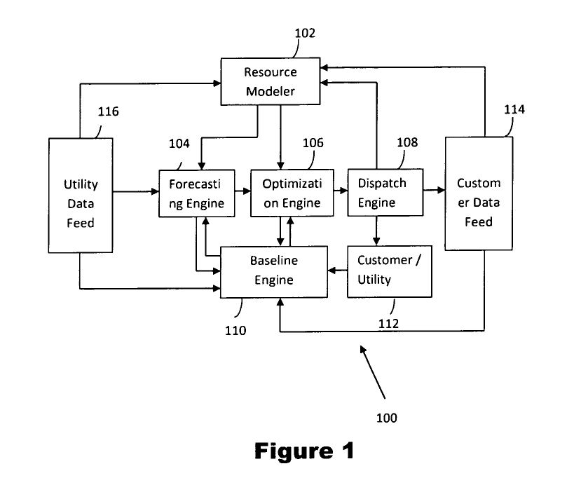

FIG. 1 is a schematic representation showing the operation of demand response optimization and management system for real time in accordance with the embodiment of the present invention. Referring to FIG. 1, a demand response optimization and management system for real time (DROMS -RT) 100 is provided. The system 100 comprising: a resource modeler 102, a forecasting engine 106, an optimizer 108, a dispatch engine 110, and a baseline engine 114. The system 100 is coupled to the utility's backend data system 104 on one side and customer end-points 112 on the other side.

The DR Resource Modeler (DRM) 102 within the system 100 keeps track of all the available DR resources, their types, their locations and other relevant characteristics such as response times, ramp-times etc. The Forecasting Engine (FE) 106 gets the list of available resources from the DR resource modeler 102. The focus of forecasting engine 106 is to perform short-term forecasts of aggregate load and available load-sheds for individual loads connected to the system 100. The Optimizer 108 takes the available resources and all the constraints from the DR Resource Modeler 102 and the forecasts of individual loads and load-sheds and error distributions from the Forecasting engine 106 to determine the optimal dispatch of demand response under a given cost functions. The Baseline Engine 114 uses signal processing techniques to identify even small systematic load sheds in the background of very large base signals. The system is coupled to customer data feed 112 on one side for receiving live data-feeds from customer end-devices. The system is coupled to utility data feed 104 on another side and the data from the utility data feed 104 is provided to calibrate the forecasting and optimization models to execute demand response events. The system 100 has a dispatch engine 110 that helps in taking decision and uses these resource specific stochastic models to dispatch demand response signals across a portfolio of customer to generate ISO bids from demand response or to optimally dispatch demand response signals to the customer based on the cleared bids and other constraints of the grid. The system uses customer/utility interface 116 connected to baseline engine that provides an interface between the system and customer or the utility.

In practice, of course, some of the feeds might not be available all the time or in real-time; the forecasting engine 106 is also able to run in an “off-line” manner or with partial data feeds in these cases. The goal of the system 100 is to provide near real-time demand response event and price signals to the customer end-points to optimally manage the available demand response resources.

The DR resource modeler 102 also continuously updates the availability of resources affected by commitment to or completion of an event. The DR resource modeler 102 also monitors the constraints associated with each resource such as the notification time requirements, number of events in a particular period and number of consecutive events. It can also monitor user preferences to determine a “loading order” as to which resources are more desirable for participation in demand response events from a customer's perspective, and the contract terms the price at which a resource is willing to participate in an event. The demand response resource modeler 102 also gets data feed from the client to determine whether the client is “online” (i.e. available as a resource) or has opted-out of the event.

The Forecasting engine 106 accounts for a number of explicit and implicit parameters and applies machine learning (ML) techniques to derive short-term load and shed forecasts as well as error distributions associated with these forecasts. The forecasting engine 106 provides baseline samples and the error distribution to the baseline engine 114. In addition, the baseline engine 114 gets the data feeds from the meter which is the actual power consumption data.

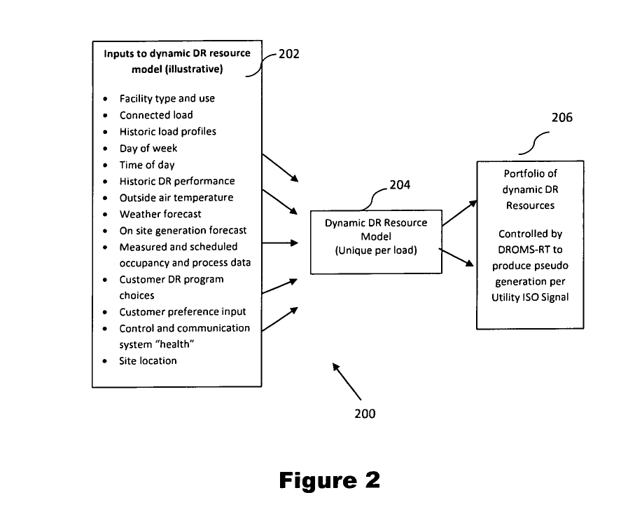

FIG. 2 illustrates a dynamic demand response resource model in accordance with an embodiment of the present invention. Referring to FIG. 2, a dynamic demand response resource model inputs and portfolio of dynamic demand response resources 200 is provided. The figure shows the various inputs to the dynamic demand response resource model 202 that are input to dynamic demand response resource model (unique per load) 204 and portfolio of dynamic demand response resources 206 controlled by the demand response optimization and management system for real time to produce pseudo generation per utility/ISO signal.

The Baseline Engine 114 verifies whether a set of customers have all met their contractual obligation in terms of load-sheds. The forecasting engine 106 provides baseline samples and the error distribution to the Baseline Engine 114. In addition the baseline engine 114 gets the data feeds from the meter which is the actual power consumption data. The baseline engine 114 uses ‘event detection’ algorithm to determine if the load actually participated in the demand response event, and if so, what the demand reduction due to this event was. The baseline engine 114 feeds data back to the forecasting engine 106 so that it could be used to improve the baseline forecast.

The overall robustness of optimization is improved by the estimation of error distribution, that further helps separate small load sheds during the events. The Forecasting engine 106 gets continuous feedback from the client devices through the baseline engine 114 and increases its forecasting ability as more data becomes available to the system. The Forecasting engine 106 can also update the demand response resource modeler 102 about the load preferences by implicitly learning what type of decisions the client devices are making to the demand response event offers.

The optimizer 108 takes the available resources and all the constraints from the demand response resource modeler 102 and the forecasts of individual loads and load-sheds and error distributions from the forecasting engine 106 to determine the optimal dispatch of demand response under a given cost functions. The Optimizer 108 can incorporate a variety of cost functions such as cost, reliability, loading order preference, GHG or their weighted sum and can make optimal dispatch decisions over a given time-horizon that could cover day-ahead and near real-time horizons simultaneously. The system 100 is able to automatically select the mix of demand response resources best suited to meet the needs of the grid such as peak load management, real-time balancing, regulation and other ancillary services. A mathematical formulation of the optimization problem is used to know how approximate dynamic programming (ADP) algorithm can be used to solve the problem. The optimization also takes into account the errors in the distribution itself and can execute a robust ADP (approximate dynamic programming) algorithm that avoids control policies that result in very abruptly changing, erratic price and demand trajectories. The optimizer 108 can also be used to generate bids for wholesale markets given the information from demand response resource module, and the wholesale market price forecasts that can be supplied externally.

The Baseline Engine 114 uses signal processing techniques to identify even small systematic load sheds in the background of very large base signals. The baseline engine 114 verifies whether a set of customers have all met their contractual obligation in terms of load-sheds. The Baseline engine 114 uses signal processing techniques to identify even small systematic load sheds in the background of very large base signals. The baseline engine 114 provides the capability of detecting demand reduction in response to demand response price notification. Novel signal processing techniques have been developed to detect small systematic load reduction in response to demand response price in a relative noise baseline environment.

The goal of the baseline engine 114 is to provide the capability of detecting demand reduction in response to a demand response event or price notification. The focus is on developing the ability to detect small systematic load reductions in response to demand response events in a relatively noisy baseline environment.

The problem of verifying whether a set of customers have all met their demand response obligations reduces to the problem of detecting a small signal (demand response related power reduction) in the background of a very large signal (baseline power consumption) and erroneous prediction of the baseline power production (model and prediction error). In order to effectively solve this problem, the baseline engine 114 needs to pull together a number of different strands from the signal processing domain.

The Baseline engine 114 deploys state of the art sparse signal processing algorithms to optimally recover demand response signals. These algorithms are optimal to the information theoretic limit, and therefore they cannot be improved unless the “SNR” of the demand response signal can be enhanced. Signal-to-noise ratio is used for measurement in science and engineering. It is defined as the ratio of signal power to the noise power.

To improve the detection even further, the baseline engine 114 employs a number of different signal-to-noise ratio enhancement strategies that range from using customer level signal aggregation to using time diversity by spreading settlement across a number of demand response events.

In addition, to the signal-to-noise ratio enhancement strategies baseline engine 114 will exploit the fact that the demand response signal is endogenous to the signal processing problem, i.e. the system 100 can select the signal. Baseline engine 114 can identify periods and locations of high and low error power and tune the demand response resource commitment to the error power—commit resources in smaller units when the error power is low and vice versa. This last step requires specific domain-specific knowledge of end user loads and load evolution—off-the-shelf clustering algorithms will be unable to cluster on the error power.

The signal-processing problem is posed as follows. Let x=(x₁, . . . , xₜ) denote the sampled data of aggregate power consumption at a particular node over T periods. The signalx_tcan be partitioned as xₜ=yₜ+εₜ−rₜ where yₜ is the baseline power consumption predicted by the forecasting and clustering models, εₜ the prediction noise, and rₜ is the DR signal. The signal demand response signal rₜ is typically small, i.e. |rₜ<<|yₜ| for all t , and also likely to be quite sparse, i.e. ∥r∥₀=Σₜ₌₁^{T}1(|rₜ|>0)<<T. Thus, the sparse signal can be recovered by solving an optimization problem of the form min ∥r∥₀+λΣₜ₌₁^{T}1(xₜ−yₜ+rₜ) where p(·) denotes the log-likelihood of the error distribution.

This problem is NP-hard and very hard to solve in practice. Under very mild regularity conditions, the solution of this optimization problem can be recovered by solving the linear program min∥r∥₁+λp(ₜ−yₜ+rₜ)−this LP is very ill-conditioned and one needs to develop special purpose codes to solve it. The current state of the art sparse algorithms can recover a sparse signal at a signal to noise ratio (SNR) of approximately 15 dB. Using signal structure, e.g. such as the fact that once “on” these signals tend to remain “on” for a certain specified period one can reduce this to about 10 dB , i.e. when the signal power is approximately equal to the noise power. Going below this lower bound on the signal-to-noise ratio is theoretically impossible.

This signal-to-noise ratio limit highlights the link between the signal processing module and the prediction module. In order to effectively detect demand response signals one has to ensure a high enough signal-to-noise ratio. Some customer centric strategies for signal-to-noise ratio enhancement are as follows.

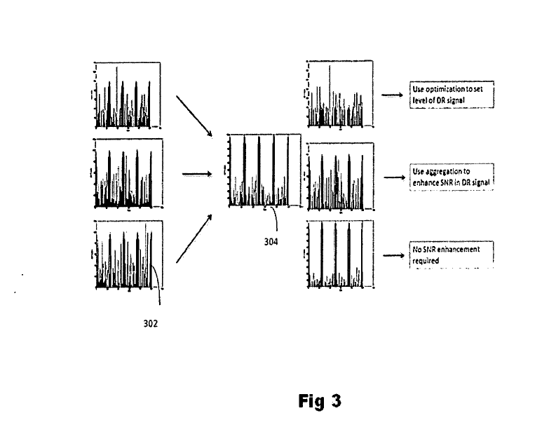

FIG. 3 is a representation illustrating alternate signal enhancement strategies and SNR enhancement via customer aggregation in accordance with an embodiment of the present invention. FIG. 3 shows when the prediction error for each customer is independent, the “portfolio effect” of combining customers increases signal-to-noise ratio. The portfolio effect” of aggregating across customers can lead to significant SNR enhancement. The alternate signal enhancement strategy 302 have high SNR but aggregating across customers leads to a significant SNR enhancement 304. The demand response is under the control of the optimizer 108; the customers can be clustered according to the prediction error and put a constraint in the optimizer 108 that can be executed in units that have the requisite Signal-to-noise ratio.

Signal-to-noise ratio can also be enhanced by time diversity, i.e. by settling demand response based payments averaged over several events. For example, if a small load is shed in one building, it may be impossible to distinguish the change by measuring the whole building meter. However, if the same small load was shed simultaneously at 1000 buildings, the uncharacterized factors tend to be smoothed allowing statistical measurement of the small load shed in each building. When the prediction errors are independent from one period to the next, the “portfolio effect” across time will reduce the noise power whereas the signal component remains relatively constant; once again enhancing signal-to-noise ratio. In case of ancillary services, there will be many events during a given time period of a day and we can aggregate data over these events to potentially improve the signal-to-noise ratio.

Demand response is under the control of the optimizer 108 in the system 100. The system 100 clusters customers according to the prediction error and put a constraint in the optimization engine to only execute demand response in units that have the requisite signal-to-noise ratio. For example, we can say that if a particular customer has a large forecasting error, demand response optimization and management system for real time 100 will exclude the customer from demand response or group that customer with 1000 other customers to take advantage of portfolio effect

The same customer may have relatively large error during some periods and low at other periods (e.g. variable during the day, stable during the night). The system 100 can identify this and limit the resource availability only during the periods of relatively smaller model error. The system 100 can also exploit time/location information by coupling the scale of the demand response resource commitment to the error power.

In an embodiment of the present invention a signal processing technique is provided that is used in baseline engine 114 for detecting small signals in the background of very large baseline signals. The technique determines the baseline signals and reduces the loads in the presence of baseline noise.

Signal processing is a technique that involves using computer algorithms to analyze and transform the signal in an effort to create natural, meaningful, and alternate representations of the useful information contained in the signal while suppressing the effects of noise. In most cases signal processing is a multi-step process that involves both numerical and graphical methods. Signal processing is a technique for analysis of signals either in distinct or continuous time to perform useful operation. Signals include sound, images, time-varying measurement values, sensor data, control system signals, telecommunication transmission signals, and radio signals.

Signal-to-noise ratio can also increase by time diversity, i.e. by settling demand response based payments averaged over several events. The enhancement of signal-to-noise ratio can be achieved in different means (see FIG. 1). When the signal-to-noise ratio is very low, the robust optimization engine should be used to ensure that demand response load is very high as compare to noise. At intermediate noise levels aggregation over customer classes is sufficient signal-to-noise ratio enhancement. At high signal-to-noise ratio means it does not require enhancement of signal-to-noise ratio and the signal can be fed to the signal processing module.

The signal-to-noise ratio (SNR) is a link between the signal processing module and the machine learning prediction and filtering module. In order to effectively detect demand response signal to assure a high enough signal-to-noise ratio the prediction error for each customer should be independent. The portfolio effect of customers also increases signal-to-noise ratio.

In an embodiment of the present invention, the signal processing techniques improve the information contained in received smart meter data. Normally, when a signal is measured with a smart meter, it is viewed in the time domain (vertical axis is amplitude or voltage and the horizontal axis is time). This is the most logical and intuitive way to view them. Simple signal processing often involves the use of gates to isolate the signal of interest or frequency filters to smooth or reject unwanted frequencies.

In an embodiment of the present invention, the invention relates to modern signal processing techniques that are able to decorrelate these signals and increase accuracy. Signal processing techniques are developing to detect small systematic load reduction in response to demand response price in relatively noise baseline environment.

By combining advanced signal processing techniques and the domain-specific engineering knowledge of the underlying data, demand response optimization and management system for real time will allow separation of small systematic load sheds as per the stringent requirements of the settlement departments of the utilities or ISO/RTO managing the demand response programs.

What is claimed is:

1. A system for optimization and management of demand response for real time power flow control for load bearing resource comprising:
a baseline engine to provide the capability of detecting demand reduction in response to a demand response event;
a means for providing utility's backend data and customer end-point data to the system;
a resource modeler for said load bearing resource communicatively coupled to utility's backend data and customer end-point data;
a first engine communicatively coupled to the said resource modeler, to forecast individual load and available load-shed for each load connected to the system and to provide aggregate load/load-shed information;
a second engine communicatively coupled to the said resource modeler, and to the said first engine to detect load reduction in response to a demand response event;
a third engine communicatively coupled to said first engine and said second engine, to calculate the optimal dispatch of demand response under a given cost function;
an optimizer communicatively connected to said third engine to determine the optimal dispatch of demand response;
a dispatch engine communicatively connected to the optimizer for dispatching demand response signals over a portfolio of customers.

2. The system of claim 1 wherein the system is offered as a software-as-a-service distribution model.

3. The system of claim 1 wherein the resource modeler tracks the information of the type, locations, characteristics, response time, ramp time and availability of the load bearing resources.

4. The system of claim 1 wherein the first engine utilizes the machine learning algorithm to forecast load and load-shed.

5. The system of claim 1 wherein the cost function considered by the optimization engine includes cost, reliability, loading order preference, GHG or their weighted sum.

6. The system of claim 1 wherein the utility's backend data is provided by utility meter management system.

7. A computer implemented method for optimization and management of demand response for real time power flow control comprising:
collecting information on the available demand response resources and determining the demand response resources that are desirable for participating in a demand response event;
performing a short-term forecast of aggregate load and available load shed for individual customers;
determining optimal dispatch of demand response under a given cost function;
integrating utility's back-end data and customer end-data for generating feedback and to identify demand response.

8. The method of claim 7 wherein the implementation is web-based and is offered under a software-as-a-service distribution model.

9. The method of claim 7 wherein the information on available demand response includes their type, locations, relevant characteristics, response time, ramp time, availability of resource to a corresponding demand response event.

10. The method of claim 7 wherein the cost function considered by the optimization engine includes cost, reliability, loading order preference, GHG or their weighted sum.

11. The method of claim 7 wherein the optimal dispatch of Demand response is calculated in form of optimal demand response bids, optimal dispatch of demand response event and price signals to customers.
